(19) United States
(12) Patent Application Publication
(10) Pub. No.: US 2013/0156931 A1
(43) Pub. Date: Jun. 20, 2013

(54) COAGULANT CONTROL FOR PRODUCING TOFU

(71) Applicants: Changjie Wang, Eindhoven (NL); Qi Zhou, Eindhoven (NL); Declan Patrick Kelly, Eindhoven (NL)

(72) Inventors: Changjie Wang, Eindhoven (NL); Qi Zhou, Eindhoven (NL); Declan Patrick Kelly, Eindhoven (NL)

(73) Assignee: KONINKLIJKE PHILIPS ELECTRONICS N.V., EINDHOVEN (NL)

(21) Appl. No.: 13/814,885

(22) PCT Filed: Sep. 5, 2011
(86) PCT No.: PCT/IB11/53869

§ 371 Date: Feb. 7, 2013

(30) Foreign Application Priority Data
Sep. 7, 2010 (CN) PCT/CN2010/076665

(51) Int. Cl. A23C 20/02

(52) U.S. Cl. CPC A23C 20/025
USPC 426/634; 99/342

(57) ABSTRACT

The invention proposes a method and apparatus for producing tofu. The apparatus comprises a first unit (100) for obtaining the electric conductivity of the water; a generator (102) for generating soymilk from soybeans and water; a first detector (104) for detecting the electric conductivity of the soymilk; a calculator (106) for calculating the amount of coagulant to be added to the soymilk, in dependence on the obtained electric conductivity of the water and the detected electric conductivity of the soymilk; and a second unit (108) for adding coagulant to the soymilk in dependence on the calculated amount. The obtained electric conductivity of the water and the detected electric conductivity of the soymilk can reflect the soymilk concentration. Thus, for each tofu-making process, the invention flexibly calculates a suitable amount of the coagulant, even if the soymilk concentration varies. The taste as well as the texture of tofu can be consistent irrespective of the soymilk concentration.

### TECHNICAL FIELD

The present invention relates to the production of tofu, more particularly to determining the amount of coagulant to be added during the production of tofu.

### BACKGROUND

In the production of tofu, an optimum amount of coagulant has to be used for the best coagulation result, and the amount depends on a number of factors:
The amount of soy beans used;
The amount of water used;
The degree of blending of the beans and the water.

Too little coagulant results in badly formed tofu, meaning that some parts of the soymilk have not formed curds. After being pressed, this tofu loses its soymilk (and its protein). Too much coagulant on the other hand will affect the taste, making the resulting tofu too firm and bitter.

Currently, tofu is generally produced in factories or workshops by means of industrial processes. In this case, the same type of soybeans and the same type of water are used, the degree of blending is fixed, thus the soymilk concentration is consistent, and the same proportion of coagulant is used, which is determined, e.g. in dependence on the previous experimental production operation and preset by the factory. Thus, tofu with a consistent taste will be produced. However, if the type of soybeans or water is changed, or the ratio between the soybeans and water changes, the soymilk concentration changes; a higher concentration means a larger total of dissolved solids in the unit of the soymilk, which requires more coagulant for making Tofu. Therefore, the factories have to adjust the amount of coagulant (by re-doing the experimental production process or refer to any other third party support) in dependence on the new type of soybeans or the water or the new ratio.

In home tofu-making, the amount of coagulant to be added to the soymilk also needs to be determined, since the soymilk concentration could vary due to a different type of beans and water used, or the different ratio of beans and water. For a common consumer, however, there is no way to measure the soymilk concentration in real time and determine the appropriate amount of coagulant accordingly.

### SUMMARY OF THE INVENTION

It would be advantageous to determine the amount of coagulant to be added to the soymilk for tofu-making, so that in spite of the concentration of the soymilk being variable, the final Tofu product can keep a similar taste and texture.

To this end, in a first aspect of the invention, there is provided a method of producing tofu, comprising the steps of: obtaining the electric conductivity of the water; generating soymilk from soybeans and water; detecting the electric conductivity of the soymilk; and calculating the amount of coagulant to be added to the soymilk in dependence on the obtained electric conductivity of the water and the detected electric conductivity of the soymilk; and adding coagulant to the soymilk in dependence on the calculated amount.

As regards said first aspect, the obtained electric conductivity of the water and the detected electric conductivity of the soymilk can reflect the concentration of ingredients such as proteins in the soymilk. Thus, for each tofu-making process, calculating a suitable amount of the coagulant according to the electric conductivity of the water and the soymilk is feasible. The taste and texture of tofu can be consistent irrespective of the concentration of the soymilk.

In one preferred embodiment, the obtaining step comprises either one of the following steps: detecting the electric conductivity of the water; retrieving the electric conductivity of the water from data stored in a memory; and receiving data related to the electric conductivity of the water.

In this preferred embodiment, the method provides several ways to obtain the electric conductivity of the water. In a first way, the actual electric conductivity of the water is detected; thus, the calculation is more accurate. In a second way, the general electric conductivity of the water in the target market can be stored in the memory and then retrieved for calculation; this implementation is simpler than the first way. In a third way, the electric conductivity of the water can be obtained more flexibly; for example, it can be input by the user himself/herself, or, it could be downloaded from the Internet such as the manufacturer's website, which is used for providing service to their customers.

In another preferred embodiment, the calculating step serves to calculate the amount of the coagulant according to the difference between the obtained electric conductivity of the water and the detected electric conductivity of the soymilk.

In this preferred embodiment, the difference between the two electric conductivities reflects the total of the dissolved solids in the soymilk more accurately. Thus, the amount of coagulant is calculated according to the total of the dissolved solids, and the calculation is more accurate.

In still another preferred embodiment, the generating step serves to generate raw soymilk from soybeans and water, and the method further comprises the step of: heating the raw soymilk to obtain cooked soymilk; the detecting step serves to detect the electric conductivity of either the raw soymilk or the cooked soymilk.

In this preferred embodiment, measuring the electric conductivity of raw soymilk gives a more accurate estimation of the total of the dissolved solids in soymilk, since, in the heating process, there may be soy protein denaturalization, aggregation and uncertain ionic reactions, which change the ion concentration and charges in protein molecules, and thus affect the EC measurement.

In a second aspect, there is provided an apparatus for producing tofu from soybeans and water, comprising: a first unit for obtaining the electric conductivity of the water; a generator for generating soymilk from the soybeans and water; a first detector for detecting the electric conductivity of the soymilk; a calculator for calculating the amount of coagulant to be added to the soymilk in dependence on the obtained electric conductivity of the water and the detected electric conductivity of the soymilk; and a second unit for adding coagulant to the soymilk in dependence on the calculated amount.

In a third aspect, there is provided a method of controlling the amount of coagulant to be added to soymilk for producing tofu from soybeans and water, comprising the steps of: obtaining the electric conductivity of the water; detecting the electric conductivity of the soymilk; calculating the amount of coagulant to be added to the soymilk in dependence on the obtained electric conductivity of the input water and the detected electric conductivity of the soymilk.

In a fourth aspect, there is provided a device for controlling the amount of coagulant to be added to the soymilk for producing tofu from soybeans and water, comprising: a first unit for obtaining the electric conductivity of the water; a first detector for detecting the electric conductivity of the soymilk; a calculator for calculating the amount of coagulant to be added to the soymilk in dependence on the obtained electric conductivity of the water and the detected electric conductivity of the soymilk.

These and other features of the present invention will be described in detail in the embodiment part.

### BRIEF DESCRIPTION OF THE DRAWINGS

Features, aspects and advantages of the present invention will become obvious by reading the following description of non-limiting embodiments with reference to the appended drawings. In the drawings, same or similar reference numerals refer to the same or similar steps or means.

FIG. 1 shows a schematic view of the apparatus for producing tofu according to one embodiment of the invention;

FIG. 2 shows a flowchart of the method of producing tofu according to one embodiment of the invention;

FIG. 3 shows the relation between TDS in the soymilk and the difference in electric conductivity of the soymilk at different electric conductivities of the water;

FIG. 4 shows the relation between TDS in the soymilk and the difference between the electric conductivities;

FIG. 5 shows the relation between K and B on the one hand and the electric conductivities of the water on the other hand.

### DETAILED DESCRIPTION OF EMBODIMENTS

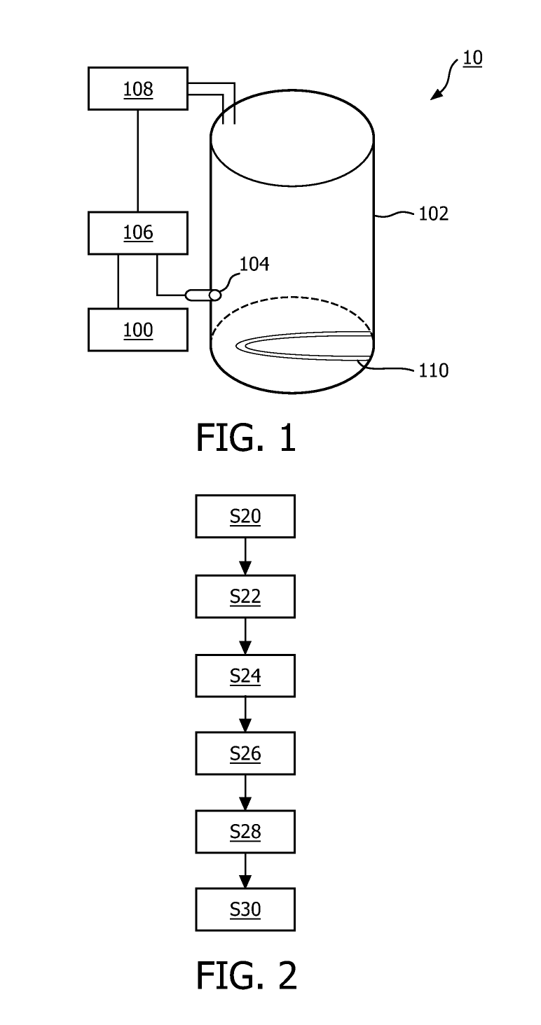

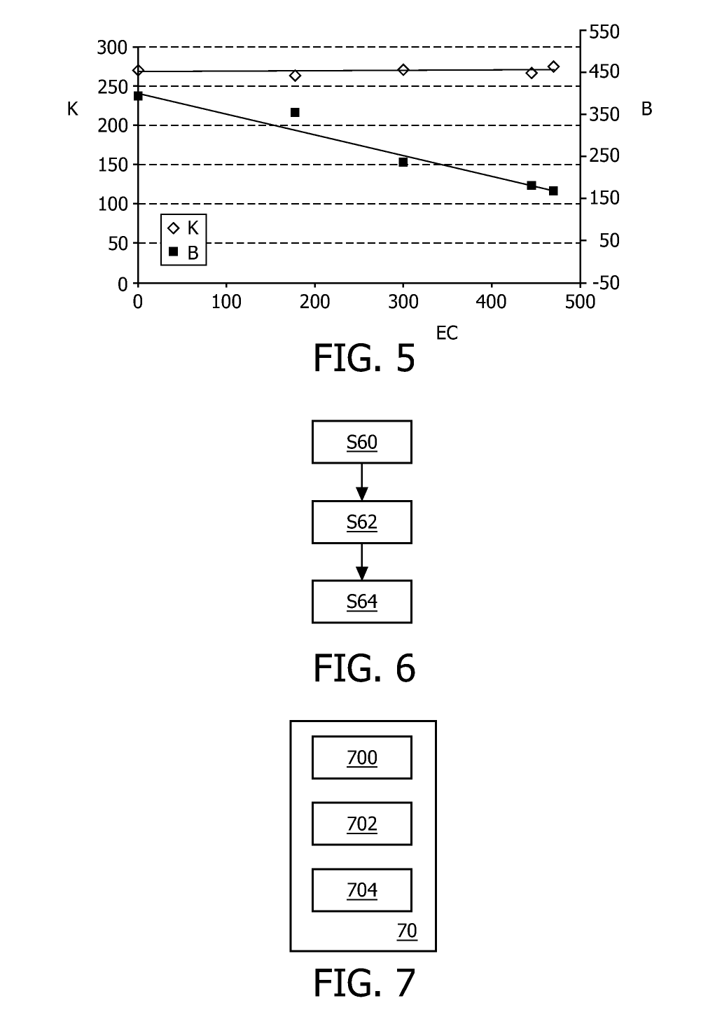

With reference to FIG. 1 and FIG. 5, the concept of the invention will be elucidated by describing the apparatus and the method according to embodiments of the invention.

As shown in FIG. 1, an apparatus 10 for producing tofu from soybeans and water comprises a first unit 100 for obtaining the electric conductivity of the water; a generator 102 for generating soymilk from soybeans and water; a first detector 104 for detecting the electric conductivity of the soymilk; a calculator 106 for calculating the amount of coagulant to be added to the soymilk in dependence on the obtained electric conductivity of the water and the detected electric conductivity of the soymilk; and a second unit 108 for adding coagulant to the soymilk in dependence on the calculated amount.

The method of producing tofu from soybeans and water comprises the steps of: obtaining the electric conductivity of the water; generating soymilk from soybeans and water; detecting the electric conductivity of the soymilk; calculating the amount of coagulant to be added to the soymilk in dependence on the obtained electric conductivity of the water and the detected electric conductivity of the soymilk; and adding coagulant to the soymilk in dependence on the calculated amount.

In one embodiment, the generator 102 comprises a tank for containing the soybeans and the water, and the user fills soybeans and water into the tank.

In step S20, the first unit 100 obtains the electric conductivity of the water.

In a first embodiment, the data of the electric conductivity of the water is pre-stored in a memory in the apparatus by the manufacturer or vendor in dependence on the general electric conductivity of the water in the target market of the apparatus 10, for example tap water in China has an average electric conductivity in the range of 500 to 600. In this embodiment, the first unit 100 comprises a third unit for retrieving the electric conductivity of the water from the data stored in the memory.

In a second embodiment, the first unit 100 comprises a receiver which receives data related to the electric conductivity of the water. The data could be input by the user from a user interface; it could also be downloaded from the Internet or any other suitable data source.

In a third embodiment, the first unit 100 comprises a second detector and the second detector detects the electric conductivity of the water added to the generator 102, before the water is used to generate soymilk together with the soybeans. As shown in FIG. 1, the electric conductivity detector can be placed in the tank of the generator 102.

In step S22, the generator 102 generates raw soymilk from the soybeans and the water. For example, the generator 102 further comprises a grinder used for grinding the soybeans. The ground soybeans and water are mixed so as to form raw soymilk.

In step S24, the first detector 104 detects the electric conductivity of the soymilk. To reduce the cost of the apparatus, the first detector 104 and the above second detector can be a single electric conductivity detector. The use of electric conductivity detectors is common knowledge to those skilled in the art, and the description will not give unnecessary details.

In step S26, the calculator 106 calculates the amount of coagulant to be added to the raw soymilk in dependence on the obtained electric conductivity of the water and the detected electric conductivity of the raw soymilk.

In a preferred embodiment, the calculator 106 calculates the amount of coagulant in dependence on the difference between the obtained electric conductivity of the water and the detected electric conductivity of the raw soymilk.

This difference in electric conductivities reflects the total of dissolved solids, such as the proteins, in the soymilk. As is known to those skilled in the art, the larger the total of dissolved solids in the soymilk, the more coagulant is needed for the coagulation. Thus, the amount of coagulant can be determined from the difference between the two electric conductivities.

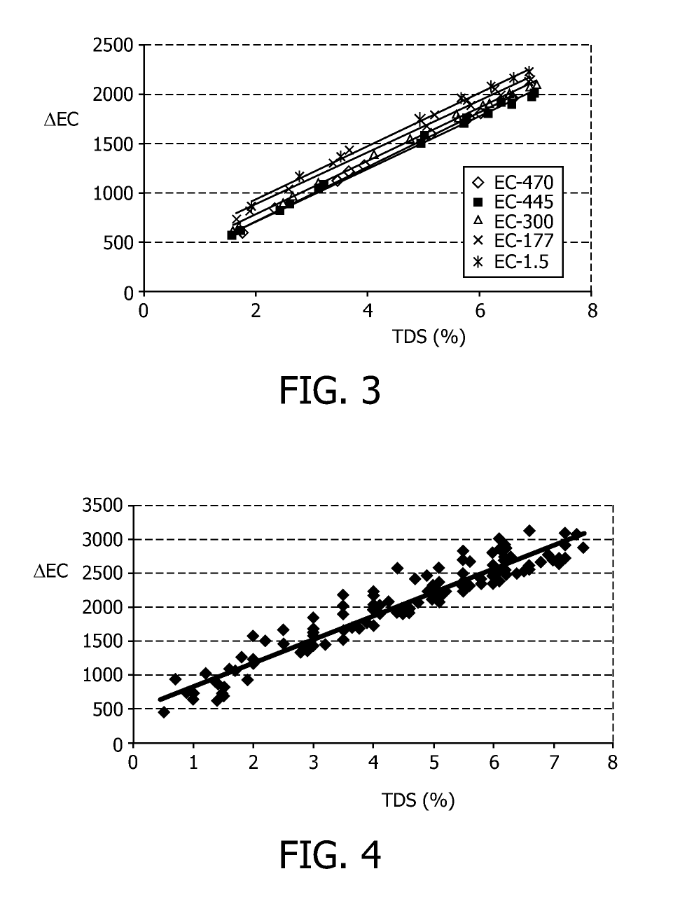

FIG. 3 shows the relation between the total of dissolved solids (TDS) in the soymilk and the difference in electric conductivities (ΔEC) at several electric conductivities of the water. The TDS can be detected chemically. As shown in FIG. 3, for each type of water with a different electric conductivity, the total of dissolved solids in the soymilk and the difference in electric conductivity all satisfy a substantially linear relation. Without loss of generality, for each given electric conductivity of the water, we can give the following equation:

ΔEC=K·TDS+B

wherein, K and B are parameters related to the given electric conductivity of the water. TDS is denoted by weight percentage (the weight of dissolved TDS/the weight of the solution)*100%), the unit of electric conductivity is μs/cm (Micro-siemens Per Centimeter).

For K, all points can be fitted to the solid curve as shown in FIG. 4, from which it can be determined that K is almost constant for all types of water with different electric conductivities.

To determine the correlation of K and B with the electric conductivity of the water, the applicant summarizes the values of K and B for each given electric conductivity of the water. FIG. 5 shows the correlation of K and B with the electric conductivity of the water (EC). It can be seen that K is substantially constant between 250 and 300, and it can be considered that B and the electric conductivity of the water satisfy a linear relation. The parameters in this linear relation can be fitted from the Figure. Thus, based on this linear relation, B can be determined from the electric conductivity of the water determined by the first unit 100 in step S20.

After B and K are determined, the total of dissolved solids can be determined as follows:

TDS=(ΔEC −B)/K

What should be understood is that: the description provides a method of determining the relation between the TDS and the electric conductivities, and those skilled in the art could use the above method to determine the practical relation between the TDS and the electric conductivities when practicing the invention. The Figures and data in the description are used for elucidating the invention without limiting it.

After the TDS of the soymilk has been determined, the calculator 106 determines the amount of coagulant to be added. Specifically, the calculator 106 calculates the amount in dependence on the total of dissolved solids in the soymilk and the volume of the soymilk, and taking into account a defined optimum amount of coagulant added per unit volume of soymilk containing said corresponding total of dissolved solids. This defined amount can be determined previously for an optimum coagulation result in terms of, for example, taste and texture. In one embodiment, for example, for 1000 ml soymilk with 7% TDS, the optimum amount of coagulant for best gel strength is 2.5 g. Thus, the amount A of coagulant to be added can be determined as follows:

A=(TDS/7%)*(V/1000 ml)*2.5 g

In a preferred embodiment, to provide more customized tofu, the calculator 106 additionally calculates the amount of coagulant in dependence on data related to the user's preferred taste and/or texture. For example, in one case, if the user prefers to make a silken tofu with a relatively soft texture, the calculator 106 further decreases the amount A by for example 20%, and obtains A′=0.8*A as the final calculated amount. In another case, if the user prefers tough tofu, the calculator 106 further increases the amount A. In other cases, an offset value of the amount can be subtracted from or added to the amount A. Those skilled in the art could use other ways of further calculating the amount of coagulant in dependence on data related to the user's preference, yet the description will not give further unnecessary details.

After the amount of coagulant to be added has been determined, in step S28, the second unit 108 adds coagulant in this amount to the raw soymilk. Depending on the practical design of the apparatus, the coagulant may be in either powder form or liquid form.

For producing tofu, the apparatus 10 further comprises a heater 110 for heating the raw soymilk to obtain cooked soymilk. The heater 110 can be for example a heating pipe installed at the bottom of the tank of the generator 102. And, in step S30, the heater 110 heats the raw soymilk with coagulant to obtain cooked soymilk with coagulant. After that, the cooked soymilk will coagulate to gel with the help of the coagulant, and the gel is then pressed to form tofu.

In an alternative embodiment, the heater 110 could heat the raw soymilk before coagulant is added, thus forming cooked soymilk without coagulant. And the second unit 108 could add coagulant to the cooked soymilk.

What is to be noted is that the heater 110 is not necessary. The user could directly add cooked soymilk to the apparatus for making tofu, and the apparatus can determine how much coagulant is to be added to the cooked soymilk by using the above mentioned method.

The above embodiments elucidate the method and apparatus for producing tofu according to two aspects of the invention. The invention further provides a device 70 and a method for controlling the amount of coagulant to be added to soymilk for producing tofu from soybeans and water. For example, as shown in FIG. 7, the device 70 comprises a first unit 700, a first detector 702 and a calculator 704. This device 70 can be incorporated into a general apparatus for producing tofu, in order to control the coagulant to be added to the soymilk. A general apparatus for producing tofu comprises a tank to contain the soybeans and water, and a grinder to grind the soybeans and mix the ground soybeans with the water to generate soymilk. As shown in FIG. 6, in step S60, the first unit 700 obtains the electric conductivity of the water before the apparatus for producing tofu generates soymilk from the soybeans and the water. Similar to the first unit 100 in the above embodiment, the first unit 700 could be a detector for detecting the electric conductivity of the water, or a unit for retrieving the electric conductivity of the water from stored data, or a receiver for receiving data related to the electric conductivity of the water. After the soymilk has been generated by the apparatus, in step S62, the first detector 702 detects the electric conductivity of the soymilk. After that, in step S64, the calculator 704 calculates the amount of coagulant to be added to the soymilk, in dependence on the obtained electric conductivity of the water and the detected electric conductivity of the soymilk. Preferably, the calculator 704 calculates the amount of the coagulant in dependence on the difference between the obtained electric conductivity of the water and the detected electric conductivity of the soymilk. The specific calculating procedure is similar to that in the above embodiment.

Although the embodiments of the present invention have been explained hereinabove in detail, it should be noted that the above-described embodiments are for illustration only, and are not to be construed as a limitation of the invention. The present invention is not limited to these embodiments.

For example, in an alternate embodiment, the first detector 104 detects the electric conductivity of the cooked soymilk after the raw soymilk has been heated by the heater 110. The second unit 108 adds coagulant to the cooked soymilk.

Further, the linear relation between the TDS and the ΔEC does not limit the invention. When practicing the invention, other relations might be discovered, and those skilled in the art could also determine the TDS according to the ΔEC based on the other relations. These implementations also fall within the protective scope of the claims.

The above units, for example the first unit, the calculator and the second unit can be implemented by way of either software, hardware or a combination thereof. For example, the program codes achieving the functions of these units are stored in a memory. These codes are loaded and executed by a MCU (Microcontroller Unit) which controls the apparatus 10. In another example, a certain IC chip achieves the functions of these units, and the chip can be controlled by the MCU. These units cooperate with the generator and the first detector. Those skilled in the art could implement embodiments of the invention in various ways according to the concept and principle taught by the description.

Those of ordinary skill in the art could understand and realize modifications to the disclosed embodiments, through studying the description, drawings and appended claims. All such modifications which do not depart from the spirit of the invention are intended to be included within the scope of the appended claims. The word “comprising” does not exclude the presence of elements or steps not listed in a claim or in the description. The word “a” or “an” preceding an element does not exclude the presence of a plurality of such elements. In the practice of the present invention, several technical features in the claim can be embodied by one component. In the claims, any reference signs placed between parentheses shall not be construed as limiting the claim.

1. A method of producing tofu from soybeans and water, the method comprising the steps of:
obtaining the electric conductivity of the water;
generating soymilk from soybeans and water;
detecting the electric conductivity of the soymilk;
calculating the amount of coagulant to be added to the soymilk in dependence on the obtained electric conductivity of the water and the detected electric conductivity of the soymilk;
adding coagulant to the soymilk in dependence on the calculated amount.

2. The method according to claim 1, wherein in the generating step raw soymilk is generated from soybeans and water, the method further comprising the step of:
heating the raw soymilk to obtain cooked soymilk;
wherein in the detecting step the electric conductivity is detected of either raw soymilk or the cooked soymilk.

3. The method according to claim 1, wherein the obtaining step comprises any one of the following steps:
detecting the electric conductivity of the water;
retrieving the electric conductivity of the water from stored data;
receiving data related to the electric conductivity of the water.

4. The method according to claim 1, wherein in the calculating step the amount of coagulant is calculated in dependence on the difference between the obtained electric conductivity of the water and the detected electric conductivity of the soymilk.

5. The method according to claim 4, wherein in the calculating step the amount of coagulant is further calculated in dependence on data related to a user's preferred taste or texture.

6. An apparatus for producing tofu from soybeans and water, comprising:
a first unit for obtaining the electric conductivity of the water;
a generator for generating soymilk from the soybeans and the water;
a first detector for detecting the electric conductivity of the soymilk;
a calculator for calculating the amount of coagulant to be added to the soymilk in dependence on the obtained electric conductivity of the water and the detected electric conductivity of the soymilk;
a second unit for adding coagulant to the soymilk in dependence on the calculated amount.

7. The apparatus according to claim 6, wherein the first unit comprises any one of the following:
a second detector for detecting the electric conductivity of the water;
a third unit for retrieving the electric conductivity of the water from data stored in a memory in the apparatus;
a receiver for receiving data related to the electric conductivity of the water.

8. The apparatus according to claim 6, wherein the calculator calculates the amount of coagulant in dependence on the difference between the obtained electric conductivity of the water and the detected electric conductivity of the soymilk.

9. The apparatus according to claim 6, wherein the generator generates raw soymilk from soybeans and water, the apparatus further comprising:
a heater for heating the raw soymilk to obtain cooked soymilk;
wherein the first detector is used for detecting the electric conductivity of either the raw soymilk or the cooked soymilk.

10. The apparatus according to claim 9, wherein the calculator additionally calculates the amount of coagulant in dependence on data related to a user's preferred taste or texture.

11. A method of controlling the amount of coagulant to be added to soymilk for producing tofu from soybeans and water, comprising the steps of:
obtaining the electric conductivity of the water;
detecting the electric conductivity of the soymilk;
calculating the amount of coagulant to be added to the soymilk in dependence on the obtained electric conductivity of the water and the detected electric conductivity of the soymilk.

12. The method according to claim 11, wherein in the calculating step the amount of the coagulant is calculated in dependence on the difference between the obtained electric conductivity of the water and the detected electric conductivity of the soymilk.

13. A device according to claim 1, wherein the controlling the amount of coagulant to be added to soymilk for producing tofu from soybeans and water, comprising:
a first unit for obtaining the electric conductivity of the water;
a first detector for detecting the electric conductivity of the soymilk;
a calculator for calculating the amount of coagulant to be added to the soymilk in dependence on the obtained electric conductivity of the water and the detected electric conductivity of the soymilk.

14. The device according to claim 13, wherein the calculator calculates the amount of coagulant in dependence on the difference between the obtained electric conductivity of the water and the detected electric conductivity of the soymilk.
